(19) United States
(12) Patent Application Publication
(10) Pub. No.: US 2009/0094458 A1
(43) Pub. Date: Apr. 9, 2009

(54) PROCESS AND SYSTEM FOR CONFIRMING TRANSACTIONS BY MEANS OF MOBILE UNITS

(75) Inventor: Ermanno Dionisio, Cellatica Bs (IT)

Correspondence Address: EDWARDS ANGELL PALMER & DODGE LLP, P.O. BOX 55874, BOSTON, MA, 02205, US

(73) Assignee: WORLDWIDE GPMS LTD, Dublin (IE)

(21) Appl. No.: 12/267,998

(22) Filed: Nov. 10, 2008

(30) Foreign Application Priority Data
May 10, 2006 (IT) PCT/IT2006/000348

(51) Int. Cl. H04L 9/30; H04W 4/12; H04M 1/00

(52) U.S. Cl. 713/171; 455/466; 455/558

(57) ABSTRACT

Process for confirming transactions by means of mobile units (MU), wherein a control device (CD) sends a request message (RM) containing transaction data (TD) to a mobile unit (MU), which can send to the control device (CD) a confirmation message (CM) containing a confirmation code (CD), wherein the control device (CD) and/or the mobile unit (MU) are provided with one or more digital memories (DM) in which security applications (SA) are stored for encoding and digitally signing the request message (RM) and/or the confirmation message (CM), respectively, before sending them. The present invention also relates to a system for carrying out said process.

### RELATED APPLICATION DATA

This application is a continuation, pursuant to 35 U.S.C. §111, of international application Ser. No. PCT/IT2006/000348, filed May 10, 2006, designating the United States and published in English on Nov. 15, 2007 as publication WO 2007/129345 A1. The entire contents of the aforementioned patent application are incorporated herein by this reference.

### FIELD OF THE INVENTION

The present invention relates to a process for confirming transactions, for example payments with credit or debit cards, by means of mobile units, for example GSM, UMTS, cellular phones, etc. The present invention also relates to a system for carrying out the process.

### BACKGROUND INFORMATION

IT MI2004A001438 in the name of the same applicant describes a process and an apparatus, in which a transaction is confirmed by means of a SMS (Short Message Service) message sent by a mobile unit of a user, after the latter has received from a control device a request message for confirming the transaction. The process and apparatus allow improving the security of the transactions with credit card and the like; however a hacker could transmit false SMS messages to the user and/or to the control device for carrying out harmful operations and/or for obtaining private data.

### SUMMARY OF THE INVENTION

An object of the present invention therefore is providing a process and an apparatus, which are free from the disadvantage. The object is achieved with a process and a system comprising a control device, a mobile unit and a SIM (Subscriber Identity Module) card, the main features of which are disclosed in the independent claim, while other features are disclosed in the remaining claims.

Thanks to the encoding and to the digital signature of the request message and/or of the confirmation message, the process and the system according to the present invention allow improving the security of the transactions, since the receivers of these messages can be sure of the identity of the senders.

According to a particular aspect of the invention, the encoding and the digital signature are carried out by means of public and private keys, preferably obtained with an asymmetric encryption algorithm, for further improving the security of the transactions. The keys, as well as the security application, which employs them, are preferably stored in the same SIM card of the telephone service provider of the mobile unit, so as to prevent their misappropriation.

### BRIEF DESCRIPTION OF THE DRAWINGS

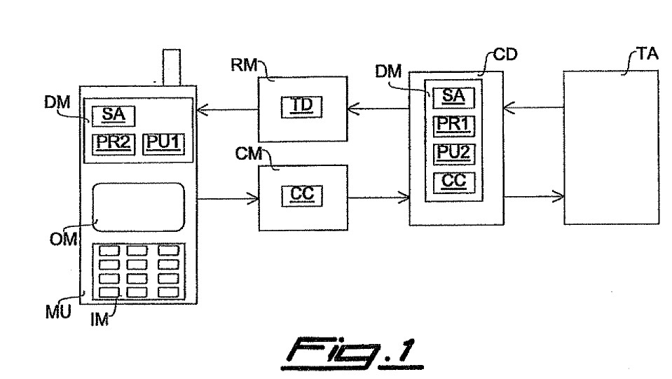

Further advantages and features of the process and the system according to the present invention will become clear to those skilled in the art from the following detailed and non-limiting description of an embodiment thereof with reference to the attached drawings, wherein FIG. 1 shows a block scheme of the system.

### DETAILED DESCRIPTION OF PREFERRED EMBODIMENTS OF THE INVENTION

Referring to FIG. 1, it is seen that the process according to the present invention comprises in a known way the following operating steps:
a user carries out a transaction with a transaction apparatus TA, for example a payment with a credit card through a POS (Point Of Sale) or Internet or a cash drawing from an ATM (Automatic Teller Machine);
the transaction data TD, for example time, date, place and amount of the transaction, are transmitted from the transaction apparatus TA to a control device CD, for example a server of a service centre connected to means for transmitting SMS messages, for requesting the user to confirm the transaction;
the control device CD sends to a mobile unit MU of the user a request message RM
   containing the transaction data TD;
the user verifies the transaction data TD through output means OM, in particular a display, of the mobile unit MU;
the user enters a confirmation code CC in the mobile unit MU through input means IM, in particular a keyboard, of the mobile unit MU;
the mobile unit MU sends to the control device CD a confirmation message CM containing the confirmation code CC;
the control device CD confirms the transaction to the transaction apparatus TA if the confirmation message CM is received within a determined time limit and contains a correct confirmation code CC, in particular a confirmation code CC associated with the mobile unit MU of the user in a digital memory DM in the control device CD.

According to the invention, the control device CD and/or the mobile unit MU are provided with one or more digital memories DM in which suitable security applications SA are stored for encoding and digitally signing the request message RM and/or the confirmation message CM, respectively.

In particular, the request message RM is digitally signed and encoded by the security application SA of the control device CD by means of a public key PU2 assigned to the mobile unit MU and a private key PR1, which is assigned to the control device CD and is stored only in the latter. The request message RM signed and encoded by the control device CD is then sent to the mobile unit MU, which decodes and verifies the digital signature of the request message RM. For this purpose, the security application SA of the mobile unit MU employs a public key PU1 assigned to the control device CD and a private key PR2, which is assigned to the mobile unit MU and is stored only in the latter.

The process according to the present invention comprises then the following operating steps:

the control device CD signs the request message RM by means of its private key PR1;

the control device CD encodes the request message RM by means of the public key PU2 of the mobile unit MU;

the control device CD sends to the mobile unit MU the signed and encoded request message RM;

the mobile unit MU decodes the request message RM by means of its private key PR2

the mobile unit MU verifies the signature of the request message RM by means of the public key PU1 of the control device CD.

If the operation has had a positive result, the request message RM is displayed by the mobile unit MU, after which the user can reply by entering the confirmation code CC for confirming the transaction or another code for cancelling the transaction or for transmitting other information to the control device CD, for example for disabling his credit card in case of fraudulent use. The confirmation message CM is digitally signed and encoded by the security application SA of the mobile unit MU by means of the public key PU1 and the private key PR2. The confirmation message CM signed and encoded by the mobile unit MU is then sent to the control device CD, which decodes and verifies the digital signature of the confirmation message CM. For this purpose, the security application SA of the control device CD employs the public key PU2 and the private key PR1.

The process comprises then also the following operating steps:

the mobile unit MU signs the confirmation message CM by means of its private key PR2;

the mobile unit MU encodes the confirmation message CM by means of the public key PUT of the control device CD;

the mobile unit MU sends to the control device CD the signed and encoded confirmation message CM,

the control device CD decodes the confirmation message CM by means of its private key PR1;

the control device CD verifies the signature of the confirmation message CM by means of the public key PU2 of the mobile unit MU.

The security applications SA of the control device CD and/or of the mobile unit MU are preferably started automatically when the confirmation message CM and/or the request message RM, respectively, are received. In particular, the request message RM and/or the confirmation message CM are SMS messages transmitted in PDU (Protocol Data Unit) mode. The security application SA, the public key PU1 assigned to the control device CD and/or the private key PR2 assigned to the mobile unit MU are preferably stored in one or more digital memories DM of a SIM card arranged in the mobile unit MU, in particular the same SIM card containing the data of the telephone service provider for the use of the mobile unit MU.

One or both pairs of public keys PU1, PU2 and private keys PR1, PR2 are preferably obtained by means of an asymmetric encryption algorithm, in particular the RSA (Rivest Shamir Adleman) algorithm, which comprises the following operating steps:

choosing two prime numbers p, q;

calculating n=pq and Φ=(p−1)(q−1);

choosing an integer number e which is less than Φ and prime to it;

calculating the integer number d such that ed=1 mod Φ;

wherein the public key PU1 or PU2 comprises the pair of values e and n, while the private key PR1 or PR2 comprises the pair of values d and n.

The encoding method of a portion m, for example one byte, of the request message RM or of the confirmation message CM for obtaining an encoded portion c comprises the operation c=m̂e mod n, while the decoding method of the encoded portion c comprises the operation m=ĉd mod n.

The signing method of a portion ni, for example one byte, of the request message RM or of the confirmation message CM for obtaining an encoded portion e comprises the operation c=m̂d mod n, while the signature verifying method of the encoded portion e comprises the operation m=ĉe mod n.

For further improving the security, the request message RM preferably contains the telephone identification number of the control device CD to which the mobile unit MU must send the confirmation message CM. The security applications SA can be written by means of known programming languages, such as for example Java and/or e/o SIM Application Toolkit. The control device CD may consist of or be connected to a second or further mobile units.

Possible modifications and/or additions may be made by those skilled in the art to the hereinabove described and illustrated embodiment of the invention while remaining within the scope of the following claims.

1. A process for confirming transactions by means of mobile units, wherein a control device sends a request message containing transaction data to a mobile unit, which can send to the control device a confirmation message containing a confirmation code, the control device and/or the mobile unit being provided with one or more digital memories in which security applications are stored for encoding and digitally signing the request message and/or the confirmation message, respectively, before sending them.

2. A process of claim 1, wherein the control device signs the request message by means of a private key of the control device.

3. A process of claim 1, wherein the control device encodes the request message by means of a public key of the mobile unit.

4. A process of claim 1, wherein the mobile unit decodes the request message by means of a private key of the mobile unit.

5. A process of claim 1, wherein the mobile unit verifies the signature of the request message by means of a public key of the control device.

6. A process of claim 1, wherein the mobile unit signs the confirmation message by means of a private key of the mobile unit.

7. A process of claim 1, wherein the mobile unit encodes the confirmation message by means of a public key of the control device.

8. A process of claim 1, wherein the control device decodes the confirmation message by means of a private key of the control device.

9. A process of claim 1, wherein the control device verifies the signature of the confirmation message by means of a public key of the mobile unit.

10. A process of claim 1, wherein the security applications of the control device and/or of the mobile unit are started automatically when the confirmation message and/or the request message, respectively, are received.

11. A process of claim 1, wherein the request message and/or the confirmation message are SMS messages transmitted in PDU mode.

12. A process of claim 1, wherein the security application, the public key of the control device and/or the private key of the mobile unit are stored in one or more digital memories of a SIM card arranged in the mobile unit.

13. A process of claim 12, wherein the SIM card contains also the data of the telephone service provider for the use of the mobile unit.

14. A process of claim 1, wherein at least one pair of public keys and private keys is obtained by means of an asymmetric encryption algorithm.

15. A process of claim 14, where the encryption algorithm comprises the following operating steps:
choosing two prime numbers p, q; calculating n=pq and Φ=(p−l)(q−1);
choosing an integer number e which is less than <fr and prime to it; calculating the integer number d such that ed=1 mod φ;
wherein the public key comprises the pair of values e and n, while the private key comprises the pair of values d and n.

16. A process of claim 15, wherein the encoding method of a portion m of the request message or of the confirmation message for obtaining an encoded portion c comprises the operation c=m̂e mod n, while the decoding method of the encoded portion c comprises the operation m=ĉd mod n.

17. A process of claim 16, wherein the signing method of a portion m of the request message or of the confirmation message for obtaining an encoded portion c comprises the operation c=m̂d mod n, while the signature verifying method of the encoded portion c comprises the operation m=ĉe mod n.

18. A process of claim 1, wherein the request message contains the telephone identification number of the control device to which the mobile unit must send the confirmation message.

19. A control device for confirming transactions, which is suitable for sending a request message containing transaction data to a mobile unit, wherein the control device is provided with one or more digital memories in which at least one security application is stored for encoding and digitally signing the request message before sending it to the mobile unit.

20-31. (canceled)

32. A mobile unit for confirming transactions, which is suitable for sending a confirmation message containing a confirmation code to a control device, wherein the mobile unit is provided with one or more digital memories in which at least one security application is stored for encoding and digitally signing the confirmation message before sending it to the control device.

33-46. (canceled)

47. A SIM card comprising one or more digital memories, wherein at least one digital memory contains a public key, a private key and/or a security application for confirming transactions by means of mobile units.

48-53. (canceled)
